(19) United States
(12) Patent Application Publication
(10) Pub. No.: US 2024/0388960 A1
(43) Pub. Date: Nov. 21, 2024

(54) DYNAMIC QUALITY OF SERVICE FOR FIXED WIRELESS ACCESS CUSTOMER PREMISES EQUIPMENT

(71) Applicant: Cisco Technology, Inc., San Jose, CA (US)

(72) Inventors: David J Mindel, Lansdale, PA (US); Sri Gundavelli, San Jose, CA (US)

(21) Appl. No.: 18/317,743

(22) Filed: May 15, 2023

(51) Int. Cl. H04W 28/02; H04W 24/08

(52) U.S. Cl. CPC H04W 28/0278; H04W 24/08; H04W 28/0284

(57) ABSTRACT

The present technology provides a method that includes establishing an initial output buffer depth of a modem for a data access point name (APN) interface by a network device. The network device includes a network operating system and a communication interface coupled between the network operating system and the modem. The method also includes monitoring traffic congestion of the modem during a predetermined time and receiving notification of backward congestion or notification of no backward congestion from the modem. The method further includes adjusting output buffer depth of the modem based on monitored traffic congestion.

### DESCRIPTION OF THE RELATED TECHNOLOGY

Fifth-generation (5G) mobile and wireless networks will provide enhanced mobile broadband communications and are intended to deliver a wider range of services and applications as compared to all prior-generation mobile and wireless networks. Compared to prior generations of mobile and wireless networks, the 5G architecture is service-based, meaning that wherever suitable, architecture elements are defined as network functions that offer their services to other network functions via common framework interfaces. To support this wide range of services and network functions across an ever-growing base of user equipment (UE), 5G networks incorporate the network slicing concept utilized in previous-generation architectures.

Within the scope of the 5G mobile and wireless network architecture, a network slice comprises a set of defined features and functionalities that together form a complete Public Land Mobile Network (PLMN) for providing services to UEs. This network slicing permits the controlled composition of a PLMN with the specific network functions and provided services that are required for a specific usage scenario. In other words, network slicing enables a 5G network operator to deploy multiple, independent PLMNs where each is customized by instantiating only those features, capabilities, and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise (e.g., any organization or business with multiple users and applications per location) requests network slices when registering with an Access and Mobility Management Function (AMF)/Mobility Management Entity (MME) for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g., based on the requirements of the services, to the enterprise.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 depicts an example schematic representation of a 5G network environment in which network slicing has been implemented, and in which one or more aspects of the present disclosure may operate according to some embodiments of the present technology;

FIG. 2 illustrates an example system diagram of a 4G or 5G network device for controlling the depth of buffer of a module or modem according to some embodiments of the present technology;

FIG. 3 illustrates an example system diagram of a 4G or 5G gateway for controlling the depth of buffer of a module or modem according to some embodiments of the present technology;

FIG. 4 illustrates an example method for dynamically adjusting the output buffer depth of the modem based on monitored traffic congestion according to some embodiments of the present technology;

FIG. 5 illustrates an example 4G or 5G router with multiple APNs or slices and QoS policies according to some embodiments of the present technology;

FIG. 6 illustrates an example 4G or 5G gateway with multiple APNs or slices and QoS policies according to some embodiments of the present technology;

FIG. 7 illustrates an exemplary network device suitable for implementing the present technology; and

FIG. 8 shows an example of a system for implementing some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Traffic prioritization and service-level agreements (SLAs) are currently ineffective for accelerating Fixed Wireless Access (FWA) enterprise cases on 4G and 5G. The disclosure provides technologies for businesses with Quality of Service (QOS). The disclosed technologies allow a network device or customer premises equipment (CPE) (e.g., router and/or gateway) to control QoS in conjunction with the modem and 4G or 5G network. By real-time communications for congestion control from the CPE to the modem, the CPE can adjust the depth of the first-in-first-out (FIFO) output buffer based on monitored traffic congestion.

In one aspect, a method includes establishing, by a network device, an initial output buffer depth of a modem for a data access point name (APN) interface. The network device includes a network operating system and a communication interface coupled between the network operating system and the modem. The method also includes monitoring traffic congestion of the modem during a predetermined time and receiving notification of backward congestion or notification of no backward congestion from the modem. The method further includes adjusting output buffer depth of the modem based on monitored traffic congestion.

In another aspect, a non-transitory computer-readable medium includes instructions, the instructions, when executed by a computing system, cause the computing system to establish, by a network device, an initial output buffer depth of a modem for a data access point name (APN). The network device includes a network operating system and a communication interface coupled between the network operating system and the modem. The instructions, when executed by a computing system, cause the computing system to monitor traffic congestion of the modem during a predetermined time. The instructions, when executed by a computing system, cause the computing system to receive notification of backward congestion or notification of no backward congestion from the modem. The instructions, when executed by a computing system, cause the computing system to adjust output buffer depth of the modem based on monitored traffic congestion.

In a further aspect, a network device includes a transceiver, a processor configured to execute instructions to cause the processor to establish, by a network device, an initial output buffer depth of a modem for a data access point name (APN) interface, wherein the network device comprises a network operating system and a communication interface coupled between the network operating system and the modem. The processor is configured to execute instructions to cause the processor to monitor traffic congestion of the modem during a predetermined time. The processor is configured to execute instructions to cause the processor to receive notification of backward congestion or notification of no backward congestion from the modem. The processor is configured to execute instructions to cause the processor to adjust output buffer depth of the modem based on monitored traffic congestion.

### Example Embodiments

QoS is ineffective in accelerating Fixed Wireless Access (FWA) enterprise use cases on 4G and 5G. FWA leverages 4G/5G as a wide-area network (WAN) access for a traditional network connection at business locations supporting multiple users accessing different applications concurrently. The 4G/5G cellular modem is embedded in the customer premises equipment (CPE) (e.g., a router and/or gateway), or is positioned outside the CPE and embedded in a gateway or cellular gateway.

3rd Generation Partnership Project (3GPP) standards focus on QoS for mobile devices and IoT devices, i.e., a device with a single user, accessing a limited set of applications requiring QoS. In these 4G/5G single-user devices (e.g., mobile handsets) QoS is often applied for an application by mapping a specific application to a specific bearer or flow. This method does not sufficiently address the need for QOS for Fixed Wireless Access. Enterprise QoS uses the DiffServ model based on differentiated service code point (DSCP) for traffic classification and treatment (prioritization, queueing, dropping). The mechanisms for 3GPP do not cover the FWA case. The 3GPP standards do not address a mechanism that provides meaningful QoS on 4G and 5G for FWA. It is difficult to accept the delay, jitter, and/or loss for business applications today. Additionally, QoS works across multiple types of local area networks (LAN) and WANs (wireline, wireless, public, private), thus the traffic classification and treatment are based on DSCP.

Between the cellular modem and CPE, there is no control mechanism to ensure QoS, which creates problems regularly seen in production connections, where the prioritization of traffic in the CPE may not be helpful for the traffic between the modem and 4G/5G network. The modems have large FIFO output buffers with low or varying uplink speeds. The deep depth of the FIFO output buffer of the modem may cause issues for router QoS, such as congestion, packet loss, and delay, among others. Additionally, the CPE sends traffic to the modem but is not aware of the actual uplink bandwidth and is also not aware of how much traffic is in the modem's FIFO queue. Also, each modem vendor or type can have different-sized output buffers. The depth of the modem's FIFO output buffer combined with the uplink speed can delay prioritized packets and impact applications or voice or video calls.

Also, the CPE traffic classes do not receive effective priority treatment due to the depth of the FIFO output queue in a 4G or 5G modem. A router or gateway with an embedded cellular modem cannot effectively queue traffic and ensure that prioritized traffic receives appropriate treatment.

Depending on the applications, packet latency, jitter, and/or loss can be kept to certain levels of proper operations and user experiences. 4G or 5G is based on radio frequency (RF) transmission. RF conditions can change the amount of available throughput, i.e., available upstream throughput may vary, which makes it difficult to maintain the levels of proper operations and user experiences.

Conventional methods including error-prone resource-intensive manual configuration may either impact the user experience or limit the full use of available upstream bandwidth. For example, a router with an embedded cellular modem interface cannot effectively queue traffic and ensure that prioritized traffic receives the treatment.

A 4G TFT or 5G 5QI may map traffic to a bearer or flow based on DSCP values, which is useful for enterprise QoS. For the enterprise QoS, there is no way for the network device or CPE to control the queueing and prioritization of packets to the 4G/5G modem. Without the control, the CPE may lose or delay packets, which affects the user experience or causes application errors.

The disclosed technology addresses the need in the art for providing enterprise QoS on a wireless network such as 4G and 5G. The disclosed technology provides real-time communications for congestion control between the modem and the network device or CPE (e.g., router or gateway). The CPE can dynamically gauge upstream bandwidth. The CPE can also dynamically set the modem's output buffer depth.

The disclosed technology does not use probing, which saves time. The disclosed technology provides a practical approach or solution regardless of modem vendors. Each modem vendor may have different protocols.

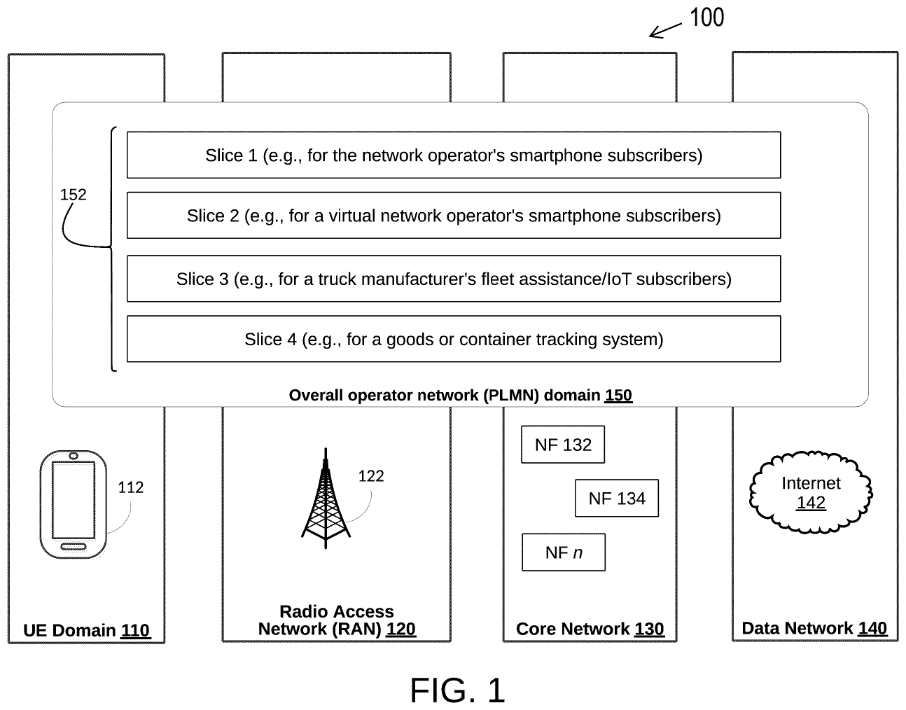

FIG. 1 depicts an exemplary schematic representation of a 5G network environment 100 in which network slicing has been implemented, and in which one or more aspects of the present disclosure may operate. As illustrated, network environment 100 is divided into four domains, each of which will be explained in greater depth below; a User Equipment (UE) domain 110, e.g. of one or more enterprises, in which a plurality of user cellphones or other connected devices 112 reside; a Radio Access Network (RAN) domain 120, in which a plurality of radio cells, base stations, towers, or other radio infrastructure 122 resides; a Core Network 130, in which a plurality of Network Functions (NFs) 132, 134, . . . , n reside; and a Data Network 140, in which one or more data communication networks such as the Internet 142 reside. Additionally, the Data Network 140 can support SaaS providers configured to provide SaaSs to enterprises, e.g. to users in the UE domain 110.

Core Network 130 contains a plurality of Network Functions (NFs), shown here as NF 132, NF 134 . . . . NF n. In some embodiments, the core network 130 is a 5G core network (5GC) in accordance with one or more accepted 5GC architectures or designs. In some embodiments, the core network 130 is an Evolved Packet Core (EPC) network, which combines aspects of the 5GC with existing 4G networks. Regardless of the particular design of core network 130, the plurality of NFs typically execute in a control plane of the core network 130, providing a service-based architecture in which a given NF allows any other authorized NFs to access its services. For example, a Session Management Function (SMF) controls session establishment, modification, release, etc., and in the course of doing so, provides other NFs with access to these constituent SMF services.

In some embodiments, the plurality of NFs of the core network 130 can include one or more Access and Mobility Management Functions (AMF; typically used when core network 130 is a 5GC network) and Mobility Management Entities (MME; typically used when core network 130 is an EPC network), collectively referred to herein as an AMF/MME for purposes of simplicity and clarity. In some embodiments, an AMF/MME can be common to or otherwise shared by multiple slices of the plurality of network slices 152, and in some embodiments, an AMF/MME can be unique to a single one of the plurality of network slices 152.

The same is true of the remaining NFs of the core network 130, which can be shared amongst one or more network slices or provided as a unique instance specific to a single one of the plurality of network slices 152. In addition to NFs comprising an AMF/MME as discussed above, the plurality of NFs of the core network 130 can additionally include one or more of the following: User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs). Various other NFs can be provided without departing from the scope of the present disclosure, as would be appreciated by one of ordinary skill in the art.

Across these four domains of the 5G network environment 100, an overall operator network domain 150 is defined. The operator network domain 150 is in some embodiments a Public Land Mobile Network (PLMN) and can be thought of as the carrier or business entity that provides cellular service to the end-users in UE domain 110. Within the operator network domain 150, a plurality of network slices 152 are created, defined, or otherwise provisioned to deliver the desired set of defined features and functionalities, e.g. SaaSs, for a certain use case or corresponding to other requirements or specifications. Note that network slicing for the plurality of network slices 152 is implemented in an end-to-end fashion, spanning multiple disparate technical and administrative domains, including management and orchestration planes (not shown). In other words, network slicing is performed from at least the enterprise or subscriber edge at UE domain 110, through the Radio Access Network (RAN) 120, through the 5G access edge and the 5G core network 130, and to the data network 140. Moreover, note that this network slicing may span multiple different 5G providers.

For example, as shown here, the plurality of network slices 152 includes Slice 1, which corresponds to smartphone subscribers of the 5G provider who also operates the network domain, and Slice 2, which corresponds to smartphone subscribers of a virtual 5G provider leasing capacity from the actual operator of network domain 150. Also shown is Slice 3, which can be provided for a fleet of connected vehicles, and Slice 4, which can be provided for an IoT goods or container tracking system across a factory network or supply chain. Note that these network slices 152 are provided for purposes of illustration, and in accordance with the present disclosure, and the operator network domain 150 can implement any number of network slices as needed and can implement these network slices for purposes, use cases, or subsets of users and user equipment in addition to those listed above. Specifically, the operator network domain 150 can implement any number of network slices for provisioning SaaSs from SaaS providers to one or more enterprises.

5G mobile and wireless networks will provide enhanced mobile broadband communications and are intended to deliver a wider range of services and applications as compared to all prior-generation mobile and wireless networks. Compared to prior generations of mobile and wireless networks, the 5G architecture is service-based, meaning that wherever suitable, architecture elements are defined as network functions that offer their services to other network functions via common framework interfaces. In order to support this wide range of services and network functions across an ever-growing base of user equipment (UE), 5G networks incorporate the network slicing concept utilized in previous-generation architectures.

Within the scope of the 5G mobile and wireless network architecture, a network slice comprises a set of defined features and functionalities that together form a complete Public Land Mobile Network (PLMN) for providing services to UEs. This network slicing permits the controlled composition of a PLMN with the specific network functions and provided services that are required for a specific usage scenario. In other words, network slicing enables a 5G network operator to deploy multiple, independent PLMNs where each is customized by instantiating only those features, capabilities, and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with AMF/MME for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g. based on the requirements of the services, to the enterprise.

Associating SaaSs and SaaS providers with network slices used to provide the SaaSs to enterprises can facilitate efficient management of SaaS provisioning to the enterprises. Specifically, an enterprise/subscriber should associate already procured SaaSs and SaaS providers with network slices being used to provision the SaaSs to the enterprise. However, associating SaaSs and SaaS providers with network slices is extremely difficult to achieve without federation across enterprises, network service providers, e.g., 5G service providers, and SaaS providers.

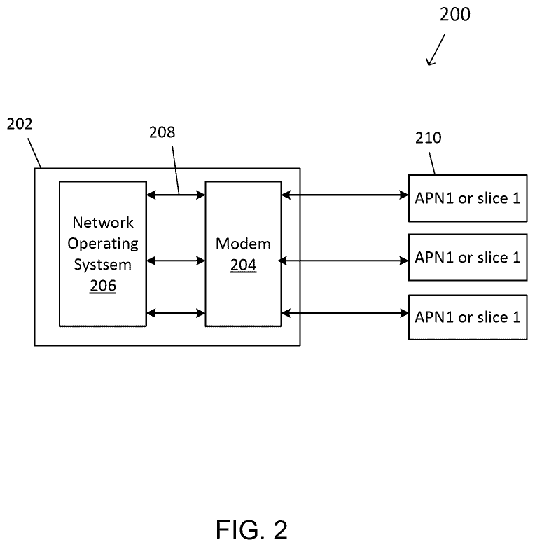

FIG. 2 illustrates an example system diagram of a 4G or 5G network device for controlling the depth of buffer of a module or modem according to some embodiments of the present technology. System 200 includes a network device 202, which may also be referred to as CPE. The network device 202 may be a router. The network device 202 includes a network operating system 206 that communicates with module or modem 204 via an interface 208. The interface may also be referred to as a network interface. Interface 208 may be a transceiver for transmitting or receiving RF signals.

The module or modem 204 may be a 4G modem or a 5G modem from any vendor. The module or modem 204 may be embedded within the network device 202. The modem 204 communicates with multiple 4G Access Point Names (APNs) or 5G slices 310A-C, as an example. The number of APNs or slices may vary.

The network device 202 (e.g., router) controls QoS on multiple LAN or WAN interfaces. The network device 202 is more capable than the module or modem 204 to determine the depth of each FIFO queue and can apply prioritization, queueing, shaping, and intelligent discard in ways the module or modem cannot.

The network device 202 can have real-time communications for congestion control with the modem 204. The CPE can monitor traffic congestion of the modem or dynamically gauge upstream 4G or 5G bandwidth congestion, then adjust the output buffer depth of the modem based on the monitored traffic congestion. The network device or CPE 202 can dynamically set the depth of the output buffer of the modem 204 based on monitored traffic congestion. When the output buffer of modem 204 is full, modem 204 can send a congestion notification to the CPE 202. The network device or CPE 202 can instruct modem 204 to reduce its output buffer size below the physical size of the output buffer of modem 204.

Dynamically gauging upstream 4G or 5G bandwidth congestion enables the CPE 202 to prioritize certain application traffic, queue other application traffic, and even discard some packets of less important traffic to meet the needs of business applications. Specifically, the CPE 202 prioritizes and queues traffic based on awareness of congestion upstream of the CPE (congestion seen by the cellular modem).

The deep depth of the FIFO buffer of the modem may cause issues for router QoS, such as congestion, packet loss, and delay, among others. The network device 202 dynamically changes the depth or size of the FIFO buffer based on traffic or congestion. The network device 202 can set the depth of the FIFO buffer of modem or cellular modem 204 to a value that allows the last packets queued to meet the delay or jitter or loss characteristics. When the FIFO buffer of modem 204 is full or nearly full, the cellular modem provides a congestion notification to the CPE. The CPE then engages a higher level of prioritization, queueing, and discard, while resizing the FIFO output buffer depth of the modem 204.

There is a conventional way for the modem to request a pause from CPE sending the modem packets. However, the conventional approach alone is insufficient to provide the QoS but is compatible with the disclosed method and can be used in the disclosed method as part of the congestion notification from the modem to the CPE.

Upstream QoS is useful for business, especially for asymmetric bandwidth connections. The QoS issues are present for 4G, 5G non-standalone (NSA), and 5G standalone (SA) in many situations. Even for 5G SA mode, there is a need for dynamic FIFO buffer depth.

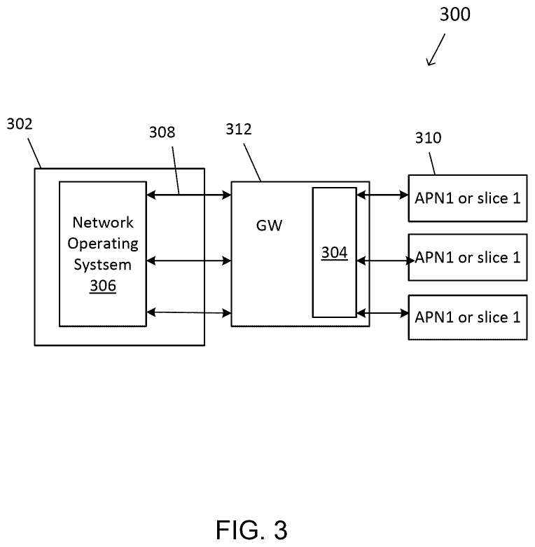

FIG. 3 illustrates an example system diagram of a 4G or 5G gateway for controlling the depth of buffer of a module or modem according to some embodiments of the present technology. A system 300 includes a network device 302, which may also be referred to as CPE. The network device 302 includes a network operating system 308.

System 300 also includes a module or modem 304 embedded in a gateway or cellular gateway 306. Gateway 306 communicates with the network operating system 308 via interface 310. Gateway 306 is a device that combines the functions of a modem and a router.

The module or modem 304 may be a 4G modem or a 5G modem. Gateway 306 may be from any vendor. The module or modem 304 is positioned outside the network device 302. The modem 304 communicates with multiple 4G APNs or 5G slices 210, as an example. The number of APNs or slices may vary.

Gateway 306 sets the depth of output buffer or FIFO buffer size for each APN or Slice in 4G or 5G modem 304. Gateway 306 dynamically changes or adjusts buffer sizes based on traffic or congestion in a 4G or 5G modem. The gateway sends congestion notification back to the network device 302 via interface 310 (e.g., GigE trunk) per virtual local area network (VLAN) or APN or Slice.

For systems 200 or 300, modem 204 or 304 can support either a FIFO output buffer per APN or slice or a single FIFO buffer. There may be a FIFO output buffer per 4G data APN or 5G slice. Although the same RF is used for multiple APNs or slices in a modem, the CPE may apply different QoS and pathing information across each APN or slice. The disclosed mechanisms can be applied to each of the APNs, slices, CPE interfaces, or sub-interfaces. The domain is between the UE (e.g., router or gateway) and the network device or CPE.

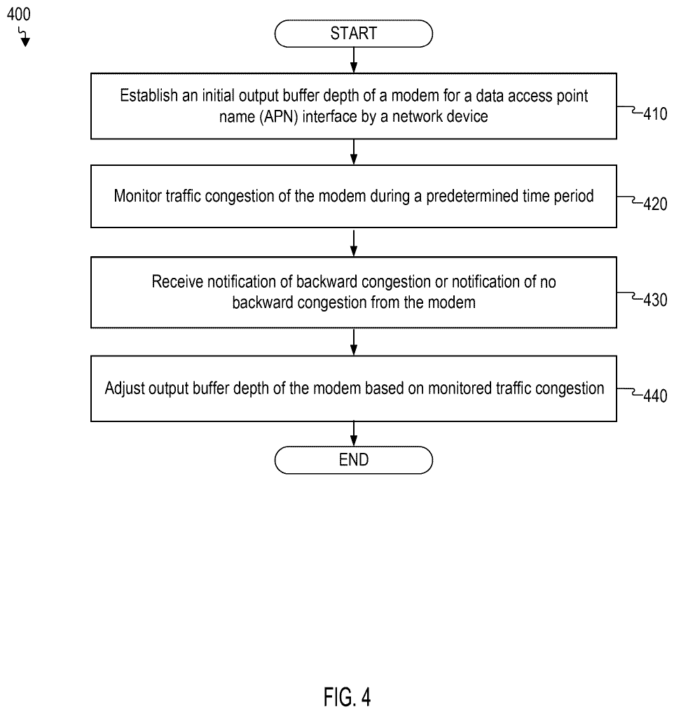

FIG. 4 illustrates an example method 400 for dynamically adjusting the output buffer depth of the modem based on monitored traffic congestion according to some embodiments of the present technology. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some examples, method 400 may include establishing an initial output buffer depth of a modem for a data access point name (APN) interface by a network device at block 410. For example, the network device 202 or 302 as illustrated in FIG. 2 or FIG. 3 may establish an initial output buffer depth of a modem for a data access point name (APN) interface. The network device 202 or 302 comprises a network operating system 206 or 308 and a communication interface coupled between the network operating system and the modem 204 or 30 In some variations, the network device may include customer premises equipment (CPE), router, or cellular gateway.

In some variations, the modem is embedded in the network device.

In some variations, the modem is positioned outside the network device and embedded in a cellular gateway that communicates with the network device.

In some variations, the data APN interface may include a plurality of data APN interfaces, wherein the communication interface comprises a plurality of communication interfaces coupled between the network operating system and the modem, wherein each of the plurality of data APN interfaces has a respective one of the plurality of communication interfaces.

According to some examples, method 400 may include monitoring traffic congestion of the modem 204 or 304 during a predetermined time at block 420. For example, the network device 202 or 302 as illustrated in FIG. 2 or FIG. 3 may monitor traffic congestion of the modem during a predetermined time.

In some variations, method 400 may include determining backward congestion of the modem, by modem 202 or 302, based on the monitored traffic congestion during the predetermined time. method 400 may also include creating a notification regarding backward congestion, wherein the notification indicates the presence or absence of backward congestion.

According to some examples, method 400 may include receiving notification of backward congestion or notification of no backward congestion from the modem at block 430. For example, the network device 202 or 302 as illustrated in FIG. 2 or FIG. 3 may receive notification of backward congestion or notification of no backward congestion from the modem.

According to some examples, method 400 may include adjusting the output buffer depth of the modem 204 or 304 based on monitored traffic congestion at block 440. For example, the network device 202 or 302 as illustrated in FIG. 2 or FIG. 3 may adjust the output buffer depth of the modem based on monitored traffic congestion.

In some variations, adjusting the output buffer depth of the modem may include sending a command to the modem to change the output buffer depth of the modem based on the backward congestion by the network device.

In some variations, sending a command to the modem to change the output buffer depth of the modem may include increasing the output buffer depth of the modem if there is no notification of backward congestion or immediately reducing the output buffer depth of the modem if there is a notification of backward congestion.

In some variations, method 400 may also include implementing a change in the output buffer depth by the modem and sending a message to the network device to confirm the change.

In the disclosure, the term “module” is interchangeably used with the phrase “cellular module” or the term “modem”. Also, the phrase “network device” is interchangeably used with the phrase “CPE”.

As disclosed above, the disclosed method dynamically adjusts the FIFO buffer depth of a cellular module or chipset (hardware or software) and brings a layer of control. Specifically, the CPE determines the FIFO buffer allocation for 3GPP connections and normalizes the control across different 4G or 5G module vendor implementations, without any change to 3GPP flows. The disclosed method ties the network device's (e.g., router and/or gateway) software queue or QoS function to the cellular hardware FIFO buffer depth to provide a method for QoS with FWA. The CPE supports multiple devices behind the CPE, and each device may have one or more flows into the network.

The disclosed method can be applied for a single slice or multiple slices provided by the cellular service. As an example, for single slice deployments, the disclosed method can be in conjunction with router QoS (traffic classification into multiple software queues, then prioritization, queueing, shaping, and policing) and with the module or chipset FIFO buffer depth. The disclosed method ensures that the single slice's FIFO buffer queue (in module or chipset) has the appropriate depth to ensure latency or jitter or loss to be within limits for appropriate application quality of experience, without upstream probing while being protocol agnostic.

The disclosed method integrates with the QoS DiffServ model, without signaling the network for specific flows or services. The disclosed method does not depend on how traffic is classified and thus can be used in a versatile fashion. The disclosed method does not use an additional FIFO queue per APN or Slice or QFI (QOS Flow ID).

### Examples

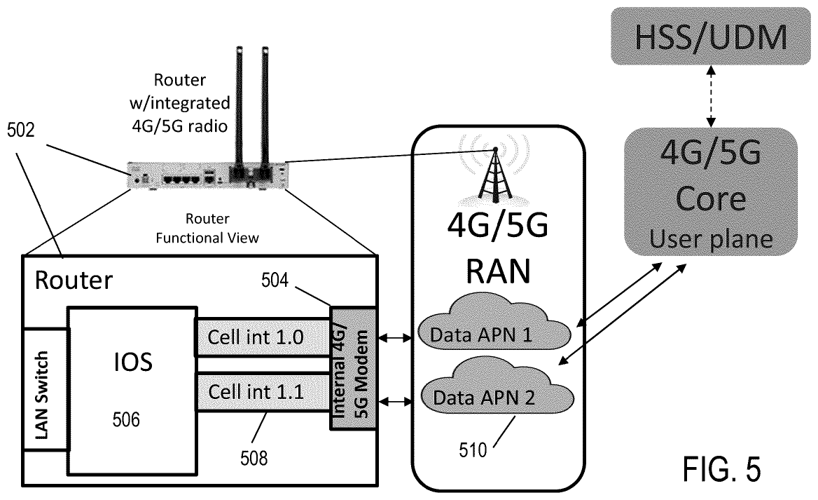

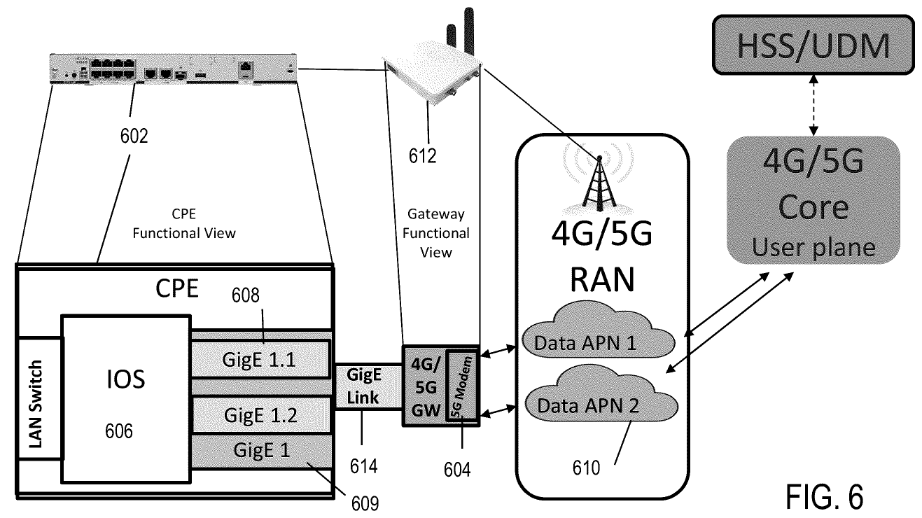

FIGS. 5-6 illustrate examples of fixed wireless access deployments. FIG. 5 illustrates an example 4G or 5G router with multiple APNs or slices and QoS policies according to some embodiments of the present technology. As illustrated in FIG. 5A, a module or modem or chipset 504 is embedded in a network device or router 502. The communication with modem 504 is internal to router 502. Messages are exchanged between the module or modem 504 and router 502. The router 502 acts as a host and manages buffer sizes across cellular modules or chipsets 504.

The disclosed method includes the following operations: operation (1) upon bootup, router 502 sets the modem FIFO output queue depth for each APN or Slice or Interface to an initial minimum value, for example, 8 KB; operation (2) after each predetermined time interval (e.g., 1 second) router 502 increases the modem FIFO output queue depth If no backward congestion notification; operation (3) if backward congestion notification is sent from modem 504 to router 502, router 502 reduces modem FIFO output queue depth for the respective APN or Slice or Interface; operation (4) the modem 504, upon receiving an increase or decrease buffer size command, implements the change and provide congestion notification based on that output buffer size and acknowledge the change.

During operations (1)-(3), router 502 performs prioritization, queueing and policing based on its defined QoS policy. For example, when the output buffer is full, a backward congestion notification is sent from modem 504 to router 502.

A specific example is provided below. The network device or CPE instructs the modem to create a FIFO output buffer for each APN or slice. The network device or CPE 502 monitors congestion from modem 504 during a predetermined time, such as 1 second, among others. If no congestion, the CPE may increase (e.g., double) the size of the FIFO output buffer, for example, starting at an initial minimum value of 8 KB, within 15 seconds, the buffer may be increased to 256 MB. Above a certain buffer size, the increase or decrease ratio can be lowered. For example, at a buffer size of 4 MB, the increase may be by 50% vs 100%, at a buffer size of 64 MB, the increase may be reduced, such as by 25%.

In some variations, the same increase or decrease ratios can be used to decrease size upon congestion.

There will likely be multiple traffic classes in a QoS policy for each FIFO output buffer or APN or Slice. QoS behavior handles prioritization and queueing for each FIFO output buffer.

FIG. 6 illustrates an example 4G or 5G gateway with multiple APNs or slices and QoS policies according to some embodiments of the present technology. As illustrated in FIG. 6, a module or chipset 604 is embedded in a cellular gateway 612 for better radio reception along with network device placement and easier or less expensive installation. In retail and enterprise deployment, the module or chipset 604 can be embedded in a cellular gateway. The cellular gateway 612 connects via Gigabit Ethernet (Gig E1.1 or GigE 1.2) interface 608 to the network device or CPE 602, where GigE means transmitting Ethernet frames at a rate of a gigabit per second. The CPE 602 includes port cable or GigE1 609. The modem 604 is positioned outside the network device or CPE 602. Messages are exchanged between the cellular gateway 612 and the network device 602 via Gigabit Ethernet (Gig E) interface 608.

The disclosed method includes the following operations: Operation (1) upon bootup, gateway 612 sets modem 604's FIFO output queue depth for each APN or Slice or Interface to an initial value; Operation (2) After each predetermined time interval (e.g., 1 second), gateway 612 instructs the 604 modem to increase its FIFO output queue depth if no backward congestion notification; Operation (3) when gateway 612 receives backward congestion notification from modem 604, gateway 612 instructs modem 604 to reduce its FIFO output queue depth for the respective APN or Slice or Interface; Operation (4) the modem 604, upon receiving an increase or decrease buffer size command, implements and acknowledges the change to gateway 612, and provides congestion notification based on the new output buffer size. (5) Whenever backward congestion notifications from modem 604 to gateway 612 are sent, gateway 612 relays the congestion notification over Gigabit Ethernet (GigE) trunk 614 to CPE 602 using an existing backward congestion notification protocol (such as IEEE 802.1Qau), per VLAN or APN or Slice or interface. When there are multiple APNs or slices, the communications are via separate VLANs on GigE trunk 614 between the CPE 602 and the cellular gateway 612, which the Ethernet standard supports. GigE trunk 614 includes bundles of multiple physical links into a logical link.

During Operation (5), when the CPE 602 receives congestion notification from gateway 612, CPE 602 engages appropriate QoS prioritization, queuing, and policing for upstream traffic to gateway 612 based on its defined QoS policy. Queuing behavior engages upon congestion. For example, when the output buffer is full, a backward congestion notification is sent from gateway 612 to CPE 602.

Appropriate output buffer depth is dependent on bit rate, which is variable over time. As a first example, if a modem's output buffer is 8 MB, the upstream rate is 10 Mbps (megabits per second), and the FIFO queue is full, a newly-queued voice packet may face a latency of 6 seconds. This latency is due to serialization delay (8 MB=64 m bits. Dividing 64 m bits by 10 Mbps yields 6.4 seconds to clear the FIFO buffer). As a second example, to meet 150 ms latency for voice on a 4G connection providing 2 Mbps, the output buffer depth does not exceed about 300 K bits, or about 40 KB (a 2 Mbps link can send 300 KB in 150 ms, 300 K bits is equivalent to 40 KB). If a second later upstream bandwidth falls to 1 Mbps, the buffer is about 20 KB.

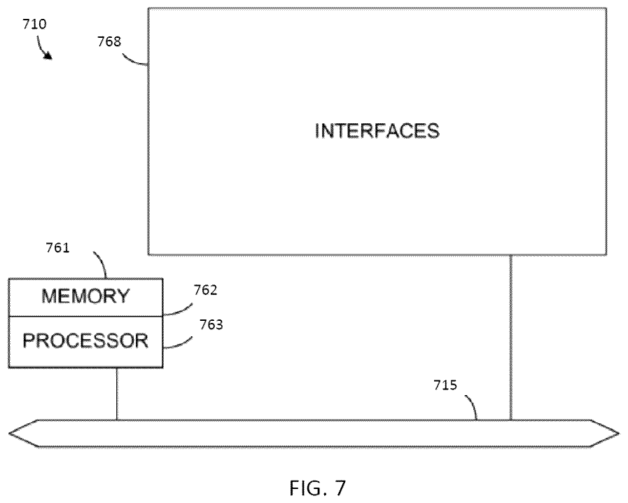

FIG. 7 illustrates an exemplary network device 710 suitable for implementing the present technology. Network device 710 includes a master central processing unit (CPU) 762, interfaces 768, and bus 715. When acting under the control of appropriate software or firmware, the CPU 762 accomplishes all these functions under the control of software including an operating system and any appropriate applications software. CPU 762 may include one or more processors 763 such as a processor from the Motorola family of microprocessors or the MIPS family of microprocessors. In an alternative embodiment, processor 763 is specially designed hardware for controlling the operations of router 710. In a specific embodiment, a memory 761 (such as non-volatile RAM and/or ROM) also forms part of CPU 762. However, there are many different ways in which memory could be coupled to the system.

Interfaces 768 are typically provided as interface cards (sometimes referred to as “line cards”). Generally, they control the sending and receiving of data packets over the network and sometimes support other peripherals used with the router 710. Among the interfaces that may be provided are Ethernet interfaces, frame relay interfaces, cable interfaces, DSL interfaces, token ring interfaces, and the like. Additionally, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, and the like. Generally, these interfaces may include ports appropriate for communication with the appropriate media. In some cases, they may also include an independent processor and, in some instances, volatile RAM. The independent processors may control such communications-intensive tasks as packet switching, media control, and management. By providing separate processors for the communications-intensive tasks, these interfaces allow the master microprocessor 762 to efficiently perform routing computations, network diagnostics, security functions, etc.

Although the system shown in FIG. 7 is one specific network device of the present technology, it is not the only network device architecture on which the present technology can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 761) configured to store program instructions for the general-purpose network operations and mechanisms for roaming, route optimization, and routing functions described herein. The program instructions may control the operation of an operating system and/or one or more applications, for example. The memory or memories may also be configured to store tables such as mobility binding, registration, and association tables, etc.

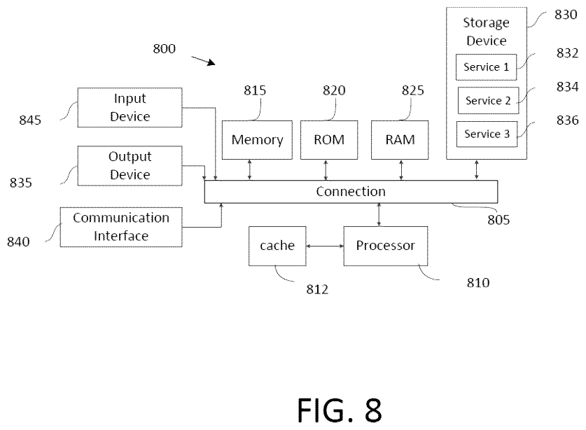

FIG. 8 shows an example of computing system 800, which can be for example any computing device making up the network operating system 206 or 308 or any component thereof in which the components of the system are in communication with each other using connection 805. Connection 805 can be a physical connection via a bus, or a direct connection to processor 810, such as in a chipset architecture. Connection 805 can also be a virtual, networked connection, or logical connection.

In some embodiments, computing system 800 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, a memory controller, a cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, a keyboard, mouse, motion input, speech, etc. Computing system 800 can also include an output device 835, which can be one or more of a number of output mechanisms known to those of skill in the art. In some instances, multimodal systems can enable a user to provide multiple types of input/output to communicate with computing system 800. Computing system 800 can include a communication interface 840, which can generally govern and manage the user input and system output. There is no restriction on operating on any particular hardware arrangement and therefore the basic features here may easily be substituted for improved hardware or firmware arrangements as they are developed.

Storage device 830 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 830 can include software services, servers, services, etc., and when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. Memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special-purpose computer, or special-purpose processing device to perform a certain function or group of functions. Portions of computer resources used can be accessible over a network. The computer-executable instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Aspect 1. A method comprising: establishing, by a network device, an initial output buffer depth of a modem for a data access point name (APN) interface, wherein the network device comprises a network operating system and a communication interface coupled between the network operating system and the modem; monitoring traffic congestion of the modem during a predetermined time; receiving notification of backward congestion or notification of no backward congestion from the modem; and adjusting output buffer depth of the modem based on a monitored traffic congestion.

Aspect 2. The method of Aspect 1, further comprising: determining backward congestion of the modem, by the modem, based on the monitored traffic congestion during the predetermined time; and creating a notification regarding the backward congestion, wherein the notification indicates the presence or absence of backward congestion.

Aspect 3. The method of any of Aspects 1 to 2, wherein adjusting the output buffer depth of the modem comprises sending a command to the modem to change the output buffer depth of the modem based on the backward congestion by the network device.

Aspect 4. The method of any of Aspects 1 to 3, wherein sending a command to the modem to change the output buffer depth of the modem comprises increasing the output buffer depth of the modem if there is no notification of backward congestion or immediately reducing the output buffer depth of the modem if there is a notification of backward congestion.

Aspect 5. The method of any of Aspects 1 to 4, further comprising implementing a change of the output buffer depth by the modem and sending a message to the network device to confirm the change.

Aspect 6. The method of any of Aspects 1 to 5, wherein the network device comprises one or more of customer premises equipment (CPE), router, and/or cellular gateway.

Aspect 7. The method of any of Aspects 1 to 6, wherein the modem is embedded in the network device.

Aspect 8. The method of any of Aspects 1 to 7, wherein the modem is positioned outside the network device and communicates with a cellular gateway that communicates with the network device.

Aspect 9. The method of any of Aspects 1 to 8, wherein the data APN interface comprises a plurality of data APN interfaces, wherein the communication interface comprises a plurality of communication interfaces coupled between the network operating system and the modem, wherein each of plurality of data APN interfaces has a respective one of the plurality of communication interfaces.

Aspect 10. A computer-readable medium comprising instructions using a computer system. The computer includes a memory (e.g., implemented in circuitry) and a processor (or multiple processors) coupled to the memory. The processor (or processors) is configured to execute the computer-readable medium and cause the processor to: establish, by a network device, an initial output buffer depth of a modem for a data access point name (APN) interface, wherein the network device comprises a network operating system and a communication interface coupled between the network operating system and the modem; monitor traffic congestion of the modem during a predetermined time; receive one of a notification of backward congestion or a notification of no backward congestion from the modem; and adjust output buffer depth of the modem based on a monitored traffic congestion.

Aspect 11. The computer-readable medium of Aspect 10, wherein the instructions, when executed by a computing system, cause the computing system to: determine a backward congestion of the modem, by the modem, based on the monitored traffic congestion during the predetermined time; and create a notification regarding the backward congestion, wherein the notification indicates presence or absence of backward congestion.

Aspect 12. The computer-readable medium of any of Aspects 10 to 11, wherein the instructions, when executed by a computing system, cause the computing system to adjust the output buffer depth of the modem comprises sending a command to the modem to change the output buffer depth of the modem based on the backward congestion by the network device.

Aspect 13. The computer-readable medium of any of Aspects 10 to 12, wherein the instructions, when executed by a computing system, cause the computing system to send a command to the modem to change the output buffer depth of the modem comprises increasing the output buffer depth of the modem if there is no notification of backward congestion or immediately reducing the output buffer depth of the modem if there is a notification of backward congestion.

Aspect 14. The computer-readable medium of any of Aspects 10 to 13, wherein the processor is configured to execute the computer-readable medium and cause the processor to: implement a change of the output buffer depth by the modem and send a message to the network device to confirm the change.

Aspect 15. The computer-readable medium of any of Aspects 10 to 14, wherein the network device comprises customer premises equipment (CPE), router, or cellular gateway.

Aspect 16. The computer-readable medium of any of Aspects 10 to 15, wherein the modem is embedded in the network device.

Aspect 17. The computer-readable medium of any of Aspects 10 to 16, wherein the modem is positioned outside the network device and communicates with a cellular gateway that communicates with the network device.

Aspect 18. The computer-readable medium of any of Aspects 10 to 17, wherein the data APN interface comprises a plurality of data APN interfaces, wherein the communication interface comprises a plurality of communication interfaces coupled between the network operating system and the modem, wherein each of plurality of data APN interfaces has a respective one of the plurality of communication interfaces.

Aspect 19. A network device includes a transceiver (e.g., a network interface, a wireless transceiver, etc.) and a processor coupled to the transceiver. The processor is configured to execute instructions and cause the processor to: establish, by a network device, an initial output buffer depth of a modem for a data access point name (APN) interface, wherein the network device comprises a network operating system and a communication interface coupled between the network operating system and the modem; monitor traffic congestion of the modem during a predetermined time; receive notification of backward congestion or notification of no backward congestion from the modem; and adjust output buffer depth of the modem based on a monitored traffic congestion.

Aspect 20. The network device of Aspect 19, wherein the processor is configured to execute instructions and cause the processor to determine backward congestion of the modem, by the modem, based on the monitored traffic congestion during the predetermined time; and create a notification regarding the backward congestion, wherein the notification indicates presence or absence of backward congestion.

Aspect 21. The network device of any of Aspects 19 to 20, wherein the processor is configured to execute instructions and cause the processor to adjust the output buffer depth of the modem comprises sending a command to the modem to change the output buffer depth of the modem based on the backward congestion by the network device.

Aspect 22. The network device of any of Aspects 19 to 21, wherein the processor is configured to execute instructions and cause the processor to send a command to the modem to change the output buffer depth of the modem comprises increasing the output buffer depth of the modem if there is no notification of backward congestion or immediately reducing the output buffer depth of the modem if there is a notification of backward congestion.

Aspect 23. The network device of any of Aspects 19 to 22, wherein the processor is configured to execute the instructions and cause the processor to implement a change of the output buffer depth by the modem and send a message to the network device to confirm the change.

Aspect 24. The network device of any of Aspects 19 to 23, wherein the network device comprises customer premises equipment (CPE), router, or cellular gateway.

Aspect 25. The network device of any of Aspects 19 to 24, wherein the modem is embedded in the network device.

Aspect 26. The network device of any of Aspects 19 to 25, wherein the modem is positioned outside the network device and embedded in a cellular gateway that communicates with the network device.

Aspect 27. The network device of any of Aspects 19 to 26, wherein the data APN interface comprises a plurality of data APN interfaces, wherein the communication interface comprises a plurality of communication interfaces coupled between the network operating system and the modem, wherein each of plurality of data APN interfaces has a respective one of the plurality of communication interfaces.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed:

1. A method comprising:
establishing, by a network device, an initial output buffer depth of a modem for a data access point name (APN) interface, wherein the network device comprises a network operating system and a communication interface coupled between the network operating system and the modem;
monitoring traffic congestion of the modem during a predetermined time;
receiving notification of backward congestion or notification of no backward congestion from the modem; and
adjusting output buffer depth of the modem based on monitored traffic congestion.

2. The method of claim 1, further comprising:
determining backward congestion of the modem, by the modem, based on the monitored traffic congestion during the predetermined time; and
creating a notification regarding backward congestion, wherein the notification indicates presence or absence of backward congestion.

3. The method of claim 1, wherein adjusting the output buffer depth of the modem comprises sending a command to the modem to change the output buffer depth of the modem based on the backward congestion by the network device.

4. The method of claim 3, wherein sending a command to the modem to change the output buffer depth of the modem comprises increasing the output buffer depth of the modem if there is no notification of backward congestion or immediately reducing the output buffer depth of the modem if there is a notification of backward congestion.

5. The method of claim 3, further comprising implementing a change of the output buffer depth by the modem and sending a message to the network device to confirm the change.

6. The method of claim 1, wherein the network device comprises one or more of customer premises equipment (CPE), router, and/or cellular gateway.

7. The method of claim 1, wherein the modem is embedded in the network device.

8. The method of claim 1, wherein the modem is positioned outside the network device and embedded in a cellular gateway that communicates with the network device.

9. The method of claim 1, wherein the data APN interface comprises a plurality of data APN interfaces, wherein the communication interface comprises a plurality of communication interfaces coupled between the network operating system and the modem, wherein each of plurality of data APN interfaces has a respective one of the plurality of communication interfaces.

10. A non-transitory computer-readable medium comprising instructions, the instructions, when executed by a computing system, cause the computing system to:
establish, by a network device, an initial output buffer depth of a modem for a data access point name (APN) interface, wherein the network device comprises a network operating system and a communication interface coupled between the network operating system and the modem;
monitor traffic congestion of the modem during a predetermined time;
receive notification of backward congestion or notification of no backward congestion from the modem; and
adjust output buffer depth of the modem based on monitored traffic congestion.

11. The computer-readable medium of claim 10, wherein the instructions, when executed by a computing system, cause the computing system to:
determine backward congestion of the modem, by the modem, based on the monitored traffic congestion during the predetermined time; and
create notification regarding the backward congestion, wherein the notification indicates presence or absence of backward congestion.

12. The computer-readable medium of claim 10, wherein the instructions, when executed by a computing system, cause the computing system to adjust the output buffer depth of the modem comprises sending a command to the modem to change the output buffer depth of the modem based on the backward congestion by the network device.

13. The computer-readable medium of claim 12, wherein the instructions, when executed by a computing system, cause the computing system to send a command to the modem to change the output buffer depth of the modem comprises increasing the output buffer depth of the modem if there is no notification of backward congestion or immediately reducing the output buffer depth of the modem if there is a notification of backward congestion.

14. The computer-readable medium of claim 12, wherein the computer-readable medium further comprises instructions that, when executed by the computing system, cause the computing system to implement a change of the output buffer depth by the modem and send a message to the network device to confirm the change.

15. The computer-readable medium of claim 10, wherein the network device comprises customer premises equipment (CPE), router, or cellular gateway.

16. The computer-readable medium of claim 10, wherein the modem is embedded in the network device.

17. The computer-readable medium of claim 10, wherein the modem is positioned outside the network device and embedded in a cellular gateway that communicates with the network device.

18. The computer-readable medium of claim 10, wherein the data APN interface comprises a plurality of data APN interfaces, wherein the communication interface comprises a plurality of communication interfaces coupled between the network operating system and the modem, wherein each of plurality of data APN interfaces has a respective one of the plurality of communication interfaces.

19. A network device comprising:
a transceiver;
a processor configured to execute instructions and cause the processor to:
establish, by a network device, an initial output buffer depth of a modem for a data access point name (APN) interface, wherein the network device comprises a network operating system and a communication interface coupled between the network operating system and the modem;
monitor traffic congestion of the modem during a predetermined time;
receive notification of backward congestion or notification of no backward congestion from the modem; and
adjust output buffer depth of the modem based on monitored traffic congestion.

20. The network device of claim 19, wherein the modem determines backward congestion of the modem based on the monitored traffic congestion during the predetermined time; and creates a notification regarding the backward congestion, wherein the notification indicates presence or absence of backward congestion.
